(19) United States
(12) Patent Application Publication
(10) Pub. No.: US 2011/0107251 A1
(43) Pub. Date: May 5, 2011

(54) USER INTERFACE FOR MONITORING THE STATUS OF MEDICAL MACHINES

(75) Inventors: Giulio Guaitoli, Carpi (IT); Michele Stefanini, Mirandola (IT); Lorenzo Orlandi, Poggio Rusco (IT)

(73) Assignee: GAMBRO LUNDIA AB, SE-22010 Lund (SE)

(21) Appl. No.: 12/999,612

(22) PCT Filed: May 14, 2009
(86) PCT No.: PCT/IB2009/005611

§ 371 Date: Dec. 16, 2010

(30) Foreign Application Priority Data
Jun. 25, 2008 (IT) MI2008A001144

(51) Int. Cl. G06F 3/048

(52) U.S. Cl. 715/772

(57) ABSTRACT

A user interface for monitoring the status of medical machines includes a display which shows data coming from a processing unit relating to parameters of the machines. The processing unit comprises means for establishing to which operating status of the medical machines the data belongs to. The processing unit determines if a medical machine is in correct functioning status; if a medical machine is in a warning status; or if a machine is in critical status. Means generate synthetic data characterised using colours according to whether the medical machine is in the correct functioning, the warning or the critical status.

### BACKGROUND OF THE INVENTION

The invention relates to a user interface for monitoring a status of medical machines and in particular a graphic user interface which enables immediate and intuitive viewing of the machine status and management of the alarms of a plurality of medical machines, for example machines for extracorporeal treatment of a fluid, for example a patient's blood, making part of a data network of medical machines, which might be a clinic or hospital network.

As is known, medical machines, such as for example machines for treatment of kidney failure or liver insufficiency or machines for plasmapheresis, i.e. machine for other types of fluid treatment are provided with an adequate graphic user interface for enabling correct monitoring of the functioning of the machine, the treatment functions underway, i.e. the parameters of the data detected and sent by the sensors and actuators which enable the treatment.

In general all the above-mentioned machines are provided with the graphic user interface and are able to signal their status by automatically advising the operator on a triggering of an alarm or a functioning problem.

Purely by way of example, document WO0226286 illustrates a medical system for perfusion provided with an alarm management on the graphic user interface. In particular, the graphic interface exhibits an area which is mainly destined to show any problems that emerge during functioning of the device.

When a problem emerges, it is automatically evaluated by the device which highlights critical alarms in red, reporting the detailed information in the mentioned area of the interface; simple notices (non-critical problems) destined to attract the attention of the user, doctor or nurse, are reported in the same area, but in yellow.

In this way an alarm hierarchy is set up, so that events requiring a more immediate intervention are highlighted more clearly.

A further example of a methodology and system for monitoring medical alarms, reporting them and normalisation is illustrated by document US2007229249.

The aim of the above patent is to centralise the signalling of alarms coming from a plurality of apparatus of completely different apparatus (heart beat monitor, infusion pumps, lung ventilators, requests for nursing intervention . . .) such as to be able to manage the alarms homogeneously and accurately.

The alarms report includes indication of the date and moment in which the alarm has been triggered, as well as its importance in connection with priority codes whether high, normal or low.

Further, a message or indication exists briefly describing what has happened. The devices briefly described above, though at least partially responding to the need to signal status and alarms in a medical machine, are however affected by some operating limitations or drawbacks.

Firstly the cited management systems perform their function very well only in the presence of a single monitored machine, or in any case having a small number of such devices.

In the presence of a large number of machines, for example connected in a network internally of a clinic, the number of alarms and signallings can be quite high, which leads to a difficulty in managing the interventions, even where the priority codes enable a first evaluation of the most urgent operations to be carried out.

Further, the reports of the alarms are in general managed in temporal order, or possibly by critical order of the single alarm that has been triggered.

In this way it is very difficult to evaluate the exact functioning of each of the machines, both in a determined moment and during the course of functioning of the machine itself over time.

Last but not least, it is worthy of note that there is also a difficulty in interpreting the data presented by the graphic user interface rapidly, in particular excluding the data which is not of importance during the consultation and viewing only the data which is of interest.

### AIM AND SUMMARY OF THE INVENTION

An aim of the present invention is substantially to resolve the cited drawbacks.

A first aim of the invention is to provide a user interface for monitoring the status of medical machines which can provide “at first glance” a significant and immediate idea of the functioning of each single machine connected to a same medical network.

A further aim of the invention is to provide the technician with data relating to the reliability of a single medical machine over a period of time, thus in particular providing data relating to the present moment and data relating to the past, and also providing the possibility of having available the detailed data relating to the machine itself or particular parameters of interest.

A further auxiliary aim of the invention is to provide a graphic user interface which enables good overall functioning of the medical device, i.e. the critical level of the overall machine status, independently of the single parameter or the plurality of parameters in the alarm state.

These and other aims will better emerge from the following description are substantially attained by a user interface for monitoring a status of medical machines as described in the accompanying claims.

Further characteristics and advantages will better emerge from the detailed description that follows of a preferred but not exclusive embodiment of the invention.

### BRIEF DESCRIPTION OF THE DRAWINGS

The preferred embodiment will now be described with reference to the accompanying figures of the drawings, in which:

FIG. 1a is a schematic view of a medical network in which the invention is inserted;

FIGS. 2 and 3 are possible schematic illustrations of means for fluid treatment which can be used in medical machines such as in FIG. 1a;

FIG. 4 schematically illustrates the connection between a plurality of medical machines and a processing unit;

FIG. 5 is a schematic diagram illustrating some operating stages of the processing unit;

FIG. 6 is a graphic user interface for monitoring the status of medical machines of the present invention; and

FIG. 7 is a further user interface used in the network of medical machines in agreement with the invention.

### DETAILED DESCRIPTION OF SOME PREFERRED EMBODIMENTS

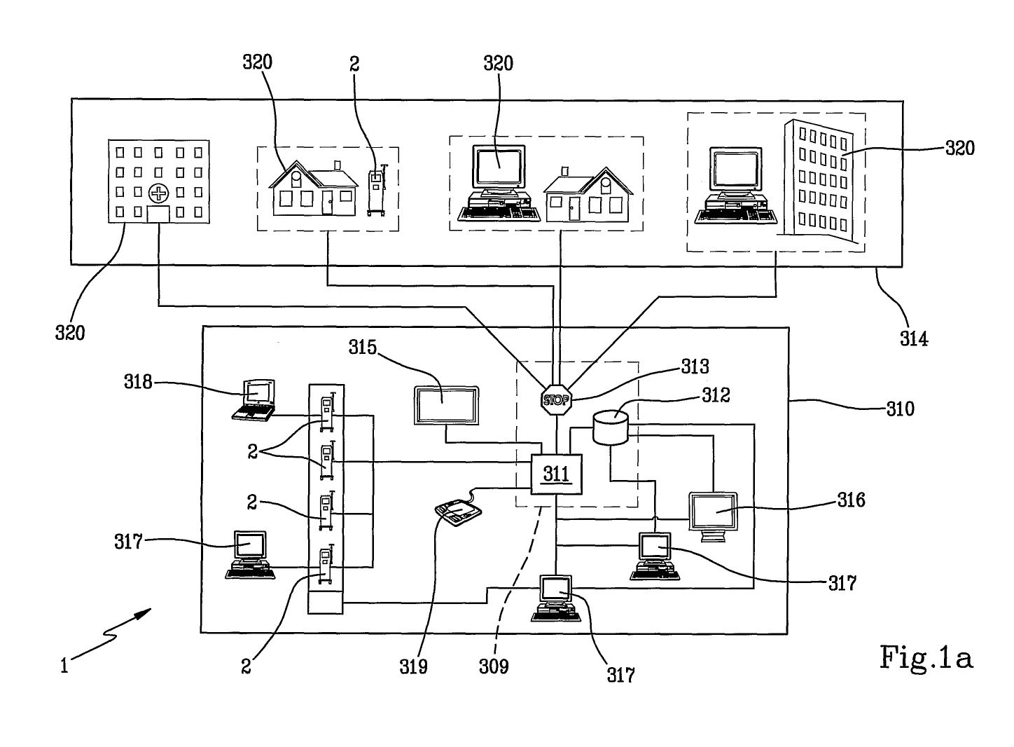

FIG. 1a is a schematic view of a medical network which internally comprises the object of the present invention.

The inset shows an example of a first portion 310 of the medical network 1 delimiting the equipment of the network which is typically present internally of a same building such as a hospital, a dialysis unit, or a clinic.

In the first portion 310 of network there is especially the presence of a plurality of medical machines 2 and in particular medical machines 2 suitable for treatment of fluids.

Medical machines 2 are in general all connected to one another and to a central server 309.

The central server 309 is constituted by at least a server computer 311 (also known as a FAM), a database 312 and special means for access 313 to the external portion 314 of the medical network 1.

As can be observed, once more schematically, there is at least one (and in general a plurality) of terminals for visual access 316 to enable personnel (in particular nursing staff) access to the data contained in the central server 309 and thus access to the network.

A plurality of desktops 317 will be connected to the network, which will have access to the central server 309, as will the medical machines 2, as will be better explained herein below.

Other apparatus can be given access, such as hand-held computers 319 or laptops 318 directly connectable to the server 309 and/or to medical machines 2 as shown in FIG. 1a.

The external portion of the network 314 includes the presence of a plurality of remote accesses 320 which can be constituted by terminals used by technicians charged with the maintenance and/or control of the functions of the medical network, medical workers' and/or doctors' terminals, patients' terminals or even patients' medical machines, or other hospitals, clinics or medical units. Access may also be granted to a home medical machine, not necessarily connected to a hospital network. In this case remote access can be performed, for example, via a remote computer provided with a suitable web browser able to communicate with a web server which the home medical machine is provided with.

In this case the network architecture can, in its most elementary form, be constituted by at least a medical machine which will be provided with a net address, and by a remote terminal which can be connected to the machine on providing the address thereof.

Obviously the use of the internet as network infrastructure will give the possibility of creating very different network architectures according to the needs of the particular case.

With reference to the above, a medical machine 2 will now be described which is suitable for fluid treatment and which be used in the medical network 1 briefly described above.

The machine can be for example a machine for blood treatment, such as a machine for treatment of kidney failure (for example a hemo(dia)filtration or hemodialysis machine, for chronic or intensive treatment) or liver insufficiency, or a machine for plasmapheresis or in any case any type of medical machine which is suitable for fluid treatment.

In the following description reference will be made to a medical machine for extracorporeal blood treatment which is essentially of known type and the components of which shall be only partially detailed.

The apparatus for fluid treatment first comprises the means 3 for blood treatment.

In particular the means 3 comprise a hydraulic circuit 100.

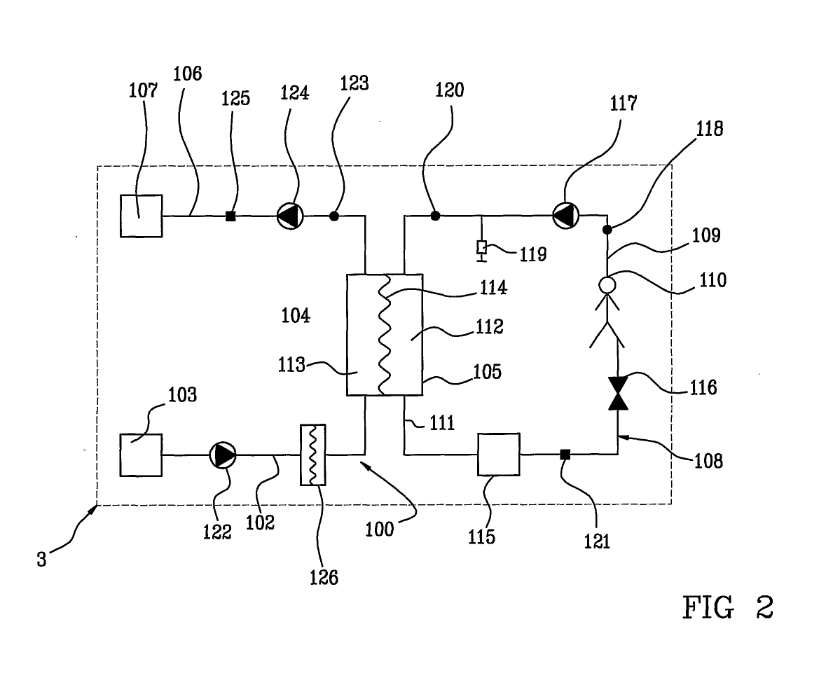

An example of realisation of hydraulic circuit is schematically shown in FIG. 2. Note that the specific structure of the hydraulic circuit 100 is not relevant for the purposes of the present invention and that circuits which are different to the one specifically shown in FIG. 2 might be adopted in view of functional design needs for each single medical apparatus. The hydraulic circuit 100 optionally exhibits at least a supply channel 102, destined for transport of a treatment liquid from at least a source 103 thereof towards a treatment station 104 where one or more blood treatment units 105 operate.

The circuit 100 further comprises at least a discharge channel 106 destined for the transport of a used liquid from the treatment station 104 towards an evacuation zone, schematically denoted by 107 in FIG. 2.

Also noteworthy is that the supply channel 102 is destined to cooperate with means for moving a fluid, such as at least a pump 122, for example a positive displacement pump, in particular either a peristaltic, gear or membrane pump. Downstream of the pump 122, along the circulation direction, a branch can be present which divides the primary circuit of the sterile fluid into an entry branch and an infusion branch (not represented but of known type).

The infusion branch is connected to the blood removal line (arterial line) and/or the blood return line (venous line) of the blood circuit and enables a direct infusion into the blood (before and/or after the blood treatment unit 105) using sterile fluid.

The entry branch takes the sterile fluid directly to the blood treatment station 104 for exchange via the membrane 114.

Obviously in this case there will be special selector means (for example constituted by a valve element and/or by means for moving, such as for example one or more pumps) for determining the percentage quantities of fluid flow in the infusion branch and the entry branch.

The sterile fluid for dialysis enters in the discharge channel 106 of the circuit and crosses a pressure sensor 123 set for control of the functioning of the line. Also present are further means for moving the fluid, for example a drainage pump 124 which can control the flow of the discharge channel 106 of the circuit. This pump too can be in general a positive displacement pump, such as for example a peristaltic pump, or a gear pump, or a membrane pump.

The fluid to be eliminated thus crosses a blood leak detector 125 and is conveyed towards the evacuation zone 107.

The treatment fluid (dialysis fluid or replacement fluid) can be previously purified by means of one or more ultrafilters 126.

The hydraulic circuit 100 cooperates with a blood circuit 108 which is also schematically represented in FIG. 2 in its basic components.

The specific structure too of the blood circuit is not fundamental with reference to the present invention and thus, with reference to FIG. 2, a brief description is provided of a possible embodiment of the circuit which must however be taken to be purely by way of example and not limiting.

The blood circuit 108 of FIG. 2 comprises an arterial line 109 for removing blood from a vascular access 110 of a patient and a venous line 111 predisposed to return the treated blood to the vascular access.

The blood circuit of FIG. 2 further comprises a first chamber, or blood, chamber 112, of the blood treatment unit 105 the second chamber of which 113 is connected to the hydraulic circuit 100.

In greater detail the arterial line 109 is connected in inlet to the blood chamber 112, while the venous line 111 is connected in outlet to the blood chamber 112. In turn, the supply channel 102 is connected in inlet to the second chamber 113, while the discharge channel 106 is connected in outlet to the second chamber.

The blood treatment unit 105, for example a dialyser or ultrafilter or a plasma filter or a hemofilter or a hemodiafilter, comprises, as mentioned, the two chambers 112, 113 which are separated by a semi-permeable membrane 114, for example having hollow fibres or plates.

Observing the arterial line 109 along the blood circulation direction from the removal zone (vascular access) towards the blood treatment unit 105, note the presence of a blood pressure sensor 118. The arterial line 109 is further connected to a device for administering an anticoagulant 119, for example a syringe pump for administering measured doses of anticoagulant (heparin).

The arterial line can thus be provided, optionally, with a further pressure sensor 120 (arranged between a pump 117 and the unit 105) which oversees the correct flow internally of the blood circuit itself.

The blood circuit can also comprise one or more air separators 115: in the example of FIG. 2 a separator 115 is provided on the venous line 111, upstream of a safety valve 116.

The treated blood exiting from the air separator device 115 crosses an air bubble sensor 121 provided for checking the absence of dangerous formations in the treated blood which has to be returned to the patient's blood circuit.

In particular, if the air bubble sensor reveals the presence of faults in the blood flow, the machine can immediately block the passage of blood, by means of the safety valve 116 (a tap, a clamp or the like), in order to prevent any type of consequence to the patient.

The valve 116 can always be activated to close the venous line should, for example, it become necessary to stop the blood return to the vascular access 110 for safety reasons.

The means 3 for treating the fluid can also comprise one or more blood pumps 117, for example volumetric pumps, such as peristaltic pumps; in the example of FIG. 2 a pump 117 is provided on the arterial line 109.

In general the hydraulic circuit 100 is housed internally of a chamber in the machine body, while the blood circuit 108 is borne by a front panel of the machine body itself which also supports the peristaltic pump and/or pumps 117. The treatment unit 105 can be physically supported, disconnectably, by fast-action attachments (of known type) arranged, for example on a lateral wall of the machine structure itself. The unit 105, in blood treatment operating conditions, is connected both to the hydraulic circuit and to the blood circuit, as briefly mentioned above.

As is intuitive and known, the means 3 for fluid treatment comprise the sensors for detecting functioning parameters of the medical machine 2 and also the actuators for intervening to modify those medical machine functioning parameters.

Each medical machine 2 in general comprises a control unit at least set for sending command signals to, and for receiving data from, the means 3 for fluid treatment.

The control unit shall therefore be active at least on the blood circuit and in particular on the pressure sensor 118, on the blood pump 117, the heparin infusion device 119, the further pressure sensor 120 and the device for detecting the presence of air bubbles 121, and on the closing element 116.

The control unit will be active on the pump 122, on the selector means, if any, on the pressure sensor 123, the drainage pump 124, and will also receive data from the blood leak detector 125.

Further, the control unit is thus also set to control the hydraulic circuit 100 of the sterile fluid and in particular will receive in inlet the collected data from any balances present on the machine and relating to the weight of the various containers used for the functioning thereof.

Obviously, apart from the checking of the sensors and the actuators as mentioned above, the control unit can be predisposed to receive and control further sensors and actuators on the machine, to guarantee and monitor their functioning.

The machine for extracorporeal blood treatment can be provided with a fluid balance system of the type used in a machine for hemodialysis and hemo(dia)filtration, for the control of weight loss in the patient during treatment, for example a flow-meter type system, or a volumetric variable-volume balancing chamber, or a balance-based system, or other systems of known type.

The machine can be provided with a system of known type, for in-line preparation of the treatment fluid (for example dialysis fluid and/or replacement fluid) starting from water and concentrates, and/or a system (of known type) for degassing and/or heating fluid which run through the system itself, and/or a purification system by means of one or more stages of ultrafiltration of the treatment fluid.

The machine can be provided with a disinfection/cleaning system (of known type, for example chemical or thermal, supplied by a distribution network or a batch source of a disinfecting/cleaning agent) of the hydraulic circuit 100.

Purely by way of example, a liquid loss sensor can also be present to detect any breakage or damage of the hydraulic circuit, which sensor will send its data directly to the control unit for processing.

The control unit can for example comprise one or more digital microprocessors or one or more analog and/or digital units.

In practice, with reference by way of example to one microprocessor unit, once the unit has run a special program (for example an externally-originated program or one directly integrated onto the motherboard of the microprocessor) it is programmed to define a plurality of modules or functional blocks which is constitute means each predisposed to perform respective operations.

The medical machine is also provided with at least a display for viewing at least a part of the data received from the control unit relating to the means 3 for fluid treatment.

Also the medical machine will be provided with at least one and generally a ao plurality of devices for entering data to be provided to the control unit for enabling the user to generate the mentioned command signals for the fluid treatment means 3.

The devices for entering data might be of different nature and can be constituted, even in combination, by a keyboard, a mouse, buttons and switches and even a touch screen.

In particular the display or screen of the medical machine 2 displays a graphic user interface (GUI) for intuitively displaying at least a part of the data received from the control unit and relating to the sensors and the actuators working on the extracorporeal blood treatment circuit.

Merely by way of non-limiting example, in a case in which a graphic user interface is used, with a touch screen configuration, the display will show various regions having a plurality of touch keys and a plurality of pictograms, each of which for example will be associated to a respective touch key.

By touch screen, a device is intended which has a screen for the output of data, used also for input by selection of parts (touch keys) of the monitor display using the fingers directly on the screen, which screen can detect the position at which the user intervened to send the appropriate commands for performing the action requested by the user to the control unit.

The use of a touch screen can for example lead to configuring the display and the device for inserting the data in a single element.

The main aim of a touch screen display is to make the interface more intuitive for the operator while at the same time simplifying the use of the machine.

The network of medical machines will advantageously be provided with at least a user interface 300 for monitoring the status of the medical machines 2 connected to the network.

A first point of note is that the graphic user interface 300 can be viewed on a display 6 which is part of one or more of the units constituting the network.

Purely by way of example, the graphic user interface 300 can be viewed on visual access terminals 316, and also on desktops 317, laptops 318, hand-held computers 319 or even remotely in one or more of the units in the remote accesses 320.

Typically the graphic user interface 300 for monitoring the status of the medical machines is of interest to the technicians charged with maintenance of the network and with control of the functioning of the various medical machines connected thereto.

In particular the processing unit 4, which can optionally be a control unit of one or more of the medical machines 2, and of the central server 309 or even the control unit of one or more of the terminals connected online, is predisposed to receive a predetermined number of data units relating to various parameters of a medical machine.

In detail, each of the medical machines 2 connected to the medical network 1 will transmit (for example to the central server 309) the data coming from the sensors and/or from the previously-mentioned actuators which will be monitored.

In general the parameters monitored can be numerous and heterogeneous according to the type of machine to be controlled and the requirements of the network and the maintenance technicians.

For example the functioning of the various electronic devices mounted on-board the medical machine can be controlled, as can the correctness of the pressure values or flows of the fluids circulating in the medical machine 2, or even the conductivity and/or the temperature thereof.

The above can occur either during machine start-up or during periodic control stages, or during all the further stages or operating conditions for functioning of the medical machine itself.

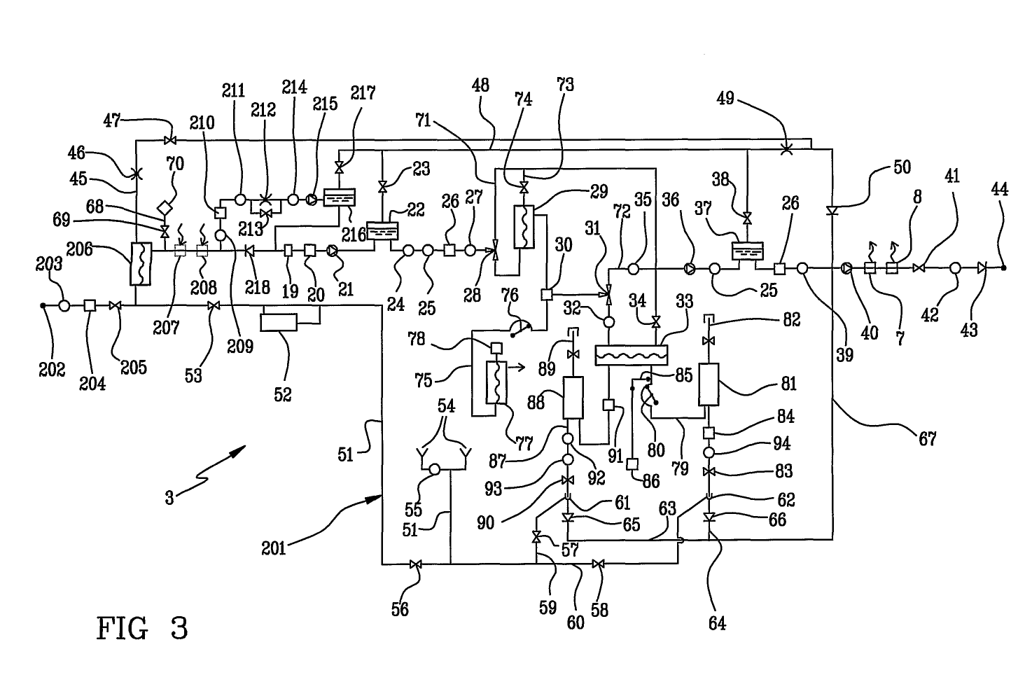

In particular, in FIG. 4 the flow of incoming data to the processing unit coming from the various medical machines is schematically represented.

Note however that the indicated data flow direction relates exclusively to the receiving of the data on the part of the processing unit 4, which will be optionally predisposed to communicate and send data, order and information to the medical machines.

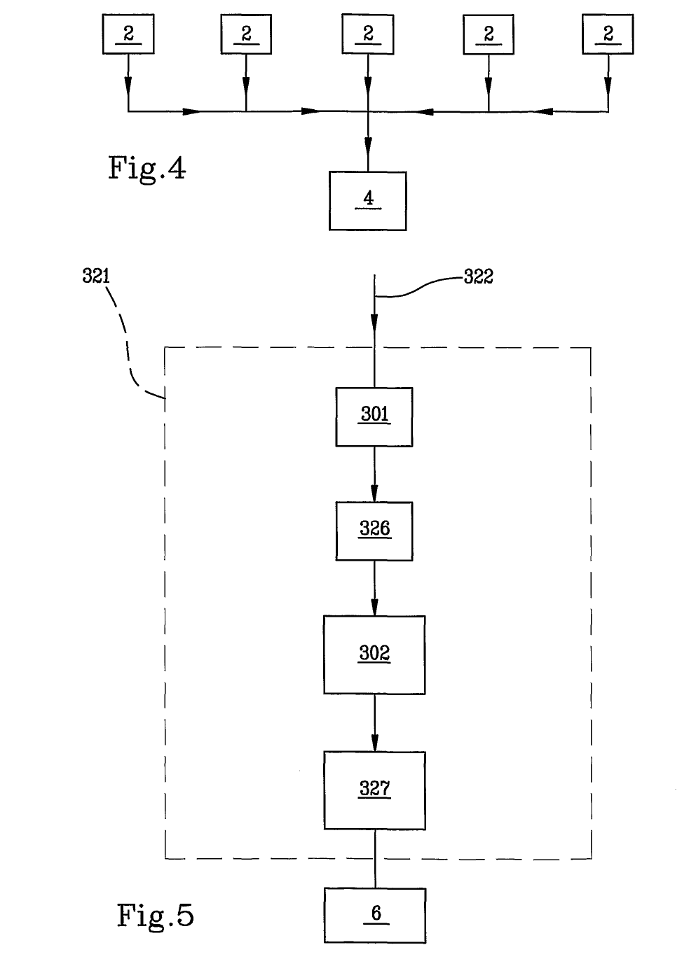

The processing unit 4 is predisposed to manage and process the incoming data relating to the various parameters of the medical machine by means of a processing module 321 illustrated in FIG. 5.

The processing module 321 will usually be constituted by a program exhibiting a number of blocks which is suitable to perform the operations now described.

Firstly the processing module 321 comprises means 301 for establishing whether the predetermined amount of data coming from a medical machine belongs to at least a respective correct functioning status, a respective warning status or a respective critical status.

In particular the incoming data 322 to the processing unit will contain at least an identification code of the machine, apart from the data relating to the above-mentioned parameters.

In particular an identifying portion of the machine will be used to identify the specific origin of the incoming data.

This i.d. could be simply the network IP address of the medical machine 2 itself. The incoming data 322 comprises a portion which contains the data relating to the above-cited parameters, and which will be evaluated.

In particular, the means for establishing belonging 301, which are briefly mentioned above, will consider each of the data units coming from a same medical machine 2 and will check that the units fall within a correct functioning range, a warning range or a critical range. Note however that the means 301 for establishing might be associated with the medical machine which would therefore already provide the processing module 321, among the incoming data 322, with the datum relating to the identification thereof.

Typically a parameter belonging to the warning range is an indication of the fact that the same parameter is close to the limits of malfunctioning or alarm; if the parameter belongs to the critical range this means that there is a potentially dangerous situation afoot, i.e. an alarm situation.

Consider for example the conductivity of a dialysis fluid which should be within an optimal operating range (i.e. in the correct functioning range).

When the value nears the upper or lower limit of the correct functioning range, the conductivity will move into a warning range, while when it goes beyond the limits it will enter the critical range.

The ranges can be defined with reference to a plurality of heterogeneous parameters and will obviously be a plurality of heterogeneous ranges, each customised to the respective parameter to be evaluated.

The processing module 321 exhibits a sub-module 326 which establishes that the medical machine 2 has a correct functioning status when the means for establishing 301 have determined that each of the data units of the medical machine belongs to the respective correct functioning status.

The sub-module 326 determines that the medical machine is in a warning condition when the means for establishing belonging 301 have determined that at least one of the data of the medical machine 2 is in the warning status range, while the other data have not passed into the critical status range.

Finally, the sub-module 326 is programmed to determine that the medical machine is in a critical status condition when the means for establishing 301 have determined that at least one of the data of the medical machine is in the critical status condition.

Once the sub-module 326 has determined the condition of the machine, means 302 for generating produce at least a syntetic data 303 corresponding to the critical status of the machine.

In particular, the syntetic data can be visually characterised differently according to the status of the medical machine, whether in correct functioning status, in warning status or in critical status.

The visual characterisation can be of various types, but in general will be such as to be immediately obvious to the technician.

In the described embodiment the medical machine when in the correct functioning condition will be represented by a brief mesasge 303 constituted by a graphic element coloured green; when in warning condition it will be represented by a graphic element coloured yellow, and when in critical condition it will be represented by a graphic element coloured red.

Alternatively the visual differentiation might be constituted by changing the pictogram associated to the condition (purely by way of example a dash for good functioning condition, a question mark for warning condition and an exclamation mark for critical condition).

Obviously any type of differentiated graphic representation can be used to supply these rapid communications on the part of the machine.

As is visible from FIG. 3, there are also means for graphically representing and positioning 327 the syntetic data 303 on the user interface 300, i.e. on the display 6, as will be better clarified herein below.

It is important that the processing unit 4 is predisposed to receive the prefixed number of data relating to parameters of the medical machine 2 in a plurality of temporally separate and successive moments.

Typically for each check function of the medical machine 2, these data are sent to the processing unit which stores them, analyses them and predisposes the correct syntetic data corresponding to the packet of data.

Via the means for representing 327 the syntetic data 303 relating to temporally separate instants are represented contemporaneously on the display 6 following a FIFO logic (First In First Out).

For example 2, 3, 4, 5 or more temporally successive checks can be represented.

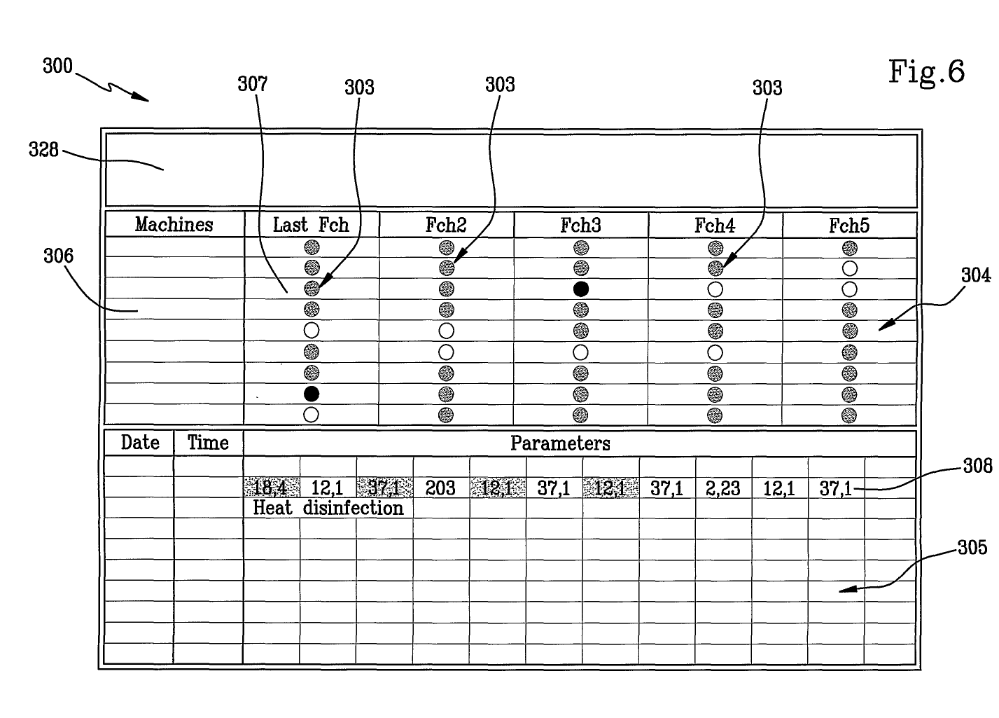

In the represented embodiment of FIG. 6 the results of five of these checks for each of the machines are illustrated.

Note that the above-described operations described with reference to a single machine are performed with reference to a prefixed number of machines connected in a network (and in general with reference to all the connected machines).

Also worthy of note is that the processing module 321 creates a syntetic data 303 for each of the machines subjected to control.

FIG. 6 illustrates how the graphic user interface 300 is programmed to define at least an information presentation area 304 on the display 6, the syntetic data 304 being relative to the medical machines 2 and at least an area of presentation of detailed information 305 relating to one medical machine, i.e. a selected syntetic data.

Observing in particular the information presentation area 304, note the presence of a zone 306 for reporting a list of medical machines 2 connected to the interface, which list is located on a line or a column (the example shown illustrates this condition); the corresponding syntetic data 303 relating to the condition of belonging of each machine is visually shown on the respective line or the respective successive column (in the graphic representation the second of these is shown).

In other words the information presentation area 304 defines a grid which reports the list of the monitored machines and, associated thereto, the syntetic data relating to the controls performed in temporal sequence from the most recent to the most remote in temporal terms.

When a further test of functionality is performed, the syntetic data 303 is shifted by one position and the temporally oldest data is no longer shown.

The interface further comprises means for active selection on the information presentation area 304 in order to enable a selection of a medical machine and/or to select a syntetic data 303.

In particular, using a mouse or keyboard, or possibly a touch screen, the medical machine of interest can be selected, i.e. the syntetic data of interest, such that the processing unit 4 can show the detailed date 308 relating to the various parameters of the medical machine and/or the syntetic data selected according to the mentioned presentation area 304.

In particular in this presentation area for detailed information will include the date and time of the most recent control (and also, optionally all or a certain number of controls already performed) and the various parameters detected at each control will be given in detailed form.

The detailed data 308 relating to the various parameters are each displayed differently according to whether the parameter belongs to the range of correct functioning, warning or critical status.

Purely by way of example the detailed data might be reported with their numbers against a green background, or yellow or red according to which status they fall into; correct, warning or critical.

The graphic user interface 300 finally comprises a selection area 328 in which the machines (from among the machines connected in the network) to be represented in the area 304 can be selected i.e. the parameters which together constitute the syntetic data 303 and/or the parameters which have to be represented in detail in the area 305.

Note finally that the area representing the detailed information 305 can also comprise a datum relating to the various operating stages of the machine, such as for example relating to the stages of disinfection performed during the same period of time with corresponding date, time and type of stage of disinfection carried out, or relating to the type of treatment performed, or other operating stages such as priming before treatment, blood return at the end of treatment, emptying of the blood circuit after treatment, washing the machine etc.

All the data represented in the time are stored in the central server 309 and in general stored in the database 312 such as to be accessible later.

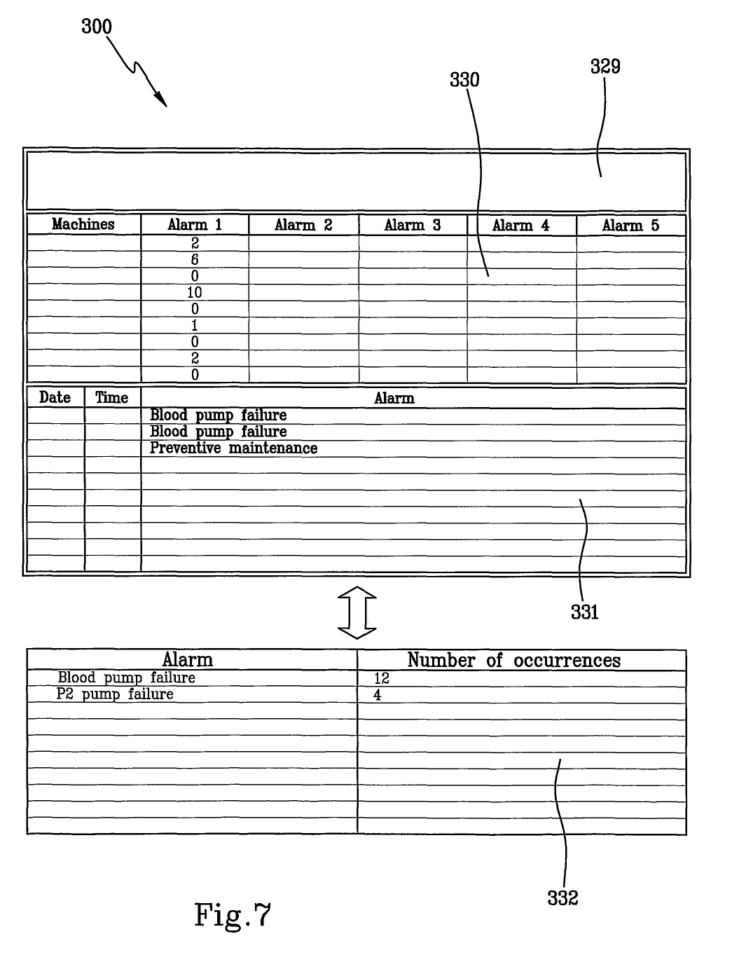

For completeness of description, note that the graphic user interface 300 can also represent all the alarms received by the machines and associate them also to the interventions of the maintaining technicians. An indication of the various intervention operations of the technicians can be shown in the area 305 and/or the area 331 of FIG. 7.

The presentation area of the detailed information 305 can appear on the screen at the same time as the syntetic data presentation area 304, or it might appear independently (not at the same time) by effect of the selection of a determined means for selecting, such as for example a region of the area 304.

As can be seen in FIG. 7, an auxiliary selection 329 will be present, in which the medical machines reported in the brief alarms area 330 can be set/filtered, as can the alarms to be shown up and the time lapse for control and synthesis. In particular, the brief alarm area 330 will show, on a line or column, the list of medical machines 2 (possibly filtered) to which the number of alarms triggered during the selected time for each shown alarm are associated.

The lower zone of the graphic user interface shows an area 331 for detailed representation of the alarms in which the alarms relating to the selected machine are indicated, as well as possibly the maintenance operations performed by the technicians.

Alternatively instead of the detailed alarm representation area 330, an area can be chosen in which, with reference to the selected machine, the problem (the cause for the alarm) associated to the number of times that alarm has been triggered can be indicated, possibly ordered starting from the alarm which has most frequently gone off and ending with the least frequent one in the time interval considered.

As mentioned, the processing unit 4 might be a control unit of a machine, or a control unit able to remotely control one or more machines, but it could also not be predisposed to control the actuators of any of the machines.

The processing unit 4 might be associated to a control unit of one of the machines, which in this case would function as a server for the machine network, or it could be independent and function as a server for the machine network separately from the control units of the various machines.

The way of briefly representing the situation of one or more medical machines might be different from what is described above. It might be possible, for example, to select, for one or more machines or for all the machines under control, a way of presenting the syntetic data in which the information is not ordered in order of time (representing the most recent n situations) but for example by degree of importance of the information/situation starting from the most serious situations (red signal) to the less serious ones (green signals). Further, it is possible to select (again using the graphic interface, for example io with touch-type regions of the screen) a representation of various machines in which the machines are ordered by seriousness of status starting from the machines with the most problematic situations (with the most serious situations, i.e. with most red signals) and going to the machines with fewer problems (with the smallest number of red or yellow signals).

It is further possible, by means of the graphic interface, to select only some determined machines from the medical network, excluding others, using various possible criteria among which, perhaps, the machines in a same room in a clinic, machines of the clinics of a certain city or region, machines of the clinics of a determined groups of clinics (for example of the same services provider), the machines of a certain versions or a determined producer, those machines which can assume a determined operating configuration (for example those which are capable of performing a certain treatment or a certain procedure, such as hemodiafiltration, acetate free biofiltration, automatic dialysis control, etc.). In substance, one or more groups of medical machines can be identified by one or two criteria. Following the same logic of aggregation of data as established above (in which the status of a machine can be identified starting from a verification of the situation of various machine parameters) is it possible equally to identify the status (red, yellow or green) of a predetermined group of machines starting from the verification of the situation (red, yellow or green) of various machines.

The invention provides important advantages.

Firstly it is worthy of note that the graphic user interface enables the technician to have an immediate and comprehensible view of the medical network situation; with reference to each machine, there is a brief and consolidated situation report, easily comprehensible and developed over time.

The presence of a syntetic data passing from a functioning condition to a warning condition signals a major probability that soon the situation will become critical and thus the need for a maintenance intervention. The substantial gain is that the need to perform preventive interventions in order to prevent further following corrective interventions can be recognised in good time, simply and with immediacy.

Further, the technician has a compact overall vision of the network.

The graphic user interface further enables checking the detailed data of interest and also to be able to filter the medical machines, i.e. the parameters of interest.

In other words, a syntetic data constituted by a green light immediately informs that, for example, all the calibration factors are correct, a yellow light informs that, for example, at least a calibration factor is in an interval such as to merit attention but that none is in a critical status; a red light informs that, for example, at least one calibration factor is in a critical status.

The above, together with the presence of a medical network which is accessible remotely enables directed, programmable and immediate interventions to be made which increase the reliability of the system, reducing the management costs thereof.

The legend of FIG. 3 is now given.
201 Hemodiafiltration apparatus
202 Water inlet
203 Inlet pressure sensor
204 Inlet pressure regulator
205 Inlet check valve
206 Inlet water ultrafilter
207 First heat exchanger
208 Second heat exchanger
209 Pressure sensor at the inlet of the heating and degassing circuit
210 heater
211 temperature sensor in the heating and degassing circuit
212 degassing restriction
213 bypass valve for degassing restriction
214 pressure sensor for control of the degassing pump
215 degassing pump
216 first gas-liquid separator in the heating and degassing circuit
217 first degassing valve
218 check valve for the heating and degassing circuit
19 pressure regulator at outlet of the heating and degassing circuit
20 on-line preparation device for dialysate with water and concentrates
21 fresh dialysate movement pump
22 second gas-liquid separator for fresh dialysate
23 second degassing valve
24 sensor system for measuring some parameters (in particular temperature, conductivity and pH) of the fresh dialysate.
25 Protection system for fluid balancing in excess at the control system
26 Fluid balancing control system
27 Pressure sensor at inlet of dialysate ultrafilter
28 First by-pass valve for by-pass of dialysate ultrafilter
29 Dialysate ultrafilter
30 Connection for a disposable replacement line
31 Second by-pass valve for dialyser by-pass
32 Pressure by-pass at dialyser inlet
33 dialyser
34 check valve at dialyser outlet
35 pressure sensor at dialyser outlet
36 used dialysate movement pump
37 third gas/separator liquid for used dialysate
38 third degassing valve
39 sensor system for measuring some used dialysate parameters (in particular temperature, conductivity, pressure and presence of blood leaks)
40 aspiration pump for stabilising the pressure downstream of the fluid balance control system
41 normally-open outlet check valve
42 outlet pressure sensor
43 check valve at outlet
44 outlet end connected to a drainage
45 water ultrafilter flushing line
46 choke on flushing line
47 flushing line check valve
48 breather circuit connected to breathers of various gas-liquid separators
49 choke connected to breathers of the various gas-liquid separators
50 check valve operating on a tract of line in common with the flushing line and the breather circuit
51 recycling circuit for complete thermal or chemical disinfection of the circuit
52 chemical disinfectant source with means for supplying the disinfectant
53 first check valve for enabling recycling during thermal or chemical disinfection
54 pair of connectors for the by-pass of the dialyser during the thermal or chemical disinfection.
55 Flow sensor in the dialyser by-pass
56 Second check valve for enabling recycling during heat or chemical disinfection
57 First check valve for enabling supply of the disinfectant to the first discharge port of the priming fluid
58 Second check valve for enabling supply of the disinfectant to the second discharge port of the priming fluid
59 First branch for disinfection of the first discharge port of the priming fluid
60 Second branch for disinfection of the first discharge port of the priming fluid
61 First discharge port of priming fluid
62 Second discharge port of priming fluid
63 First discharge line of the priming fluid
64 Second discharge line of the priming fluid
65 First check valve
66 Second check valve
67 Line joining the first and second priming fluid discharge lines with the used dialysate line
68 Line connecting to the outside environment upstream of the heating and degassing circuit
69 Check valve of the line connecting with the outside environment
70 Air filter
71 First by-pass line (by-pass of the dialysate ultrafilter)
72 Second by-pass line (by-pass of the dialysate ultrafilter)
73 Flushing line of the dialysate ultrafilter
74 Check valve of the dialysate ultrafilter flushing line
75 Replacement liquid supply line
76 Replacement liquid movement pump
77 Replacement liquid ultrafilter
78 Replacement liquid ultrafilter breather system
79 Arterial line
80 Blood pump
81 Arterial chamber
82 Arterial chamber service line
83 Arterial clamp
84 Arterial line access site
85 Anticoagulant supply line
86 Anticoagulant source
87 Venous line
88 Venous chamber
89 Venous chamber service line
90 Venous clamp
91 Venous line access site
92 Air bubble sensor
93 Blood presence sensor (patient sensor)
94 Hemoglobin and hematocrit sensor, or blood volume sensor.

1-20. (canceled)

21. A user interface for monitoring a status of medical machines, comprising:
a processing unit configured for receiving a predetermined amount of data relating to various parameters of a medical machine;
a display for visualising data coming from the processing unit and relating to the medical machine;
the processing unit comprising:
means for establishing that the predetermined amount of data coming from a same medical machine belongs to at least a status of correct functioning, or a warning status, or a critical status, the processing unit being configured to determine that the medical machine is in a condition of correct functioning when the means for establishing have determined that each of the data from the same medical machine belongs to a status of correct functioning, the processing unit being configured to determine that the medical machine is in a warning status if the means for establishing have determined that at least one datum of the data of the medical machine is in the warning status, the other data of the data not being in the critical status, the processing unit being configured to determine that the machine is in a critical status when the means for establishing have determined that at least a datum of the data of the medical machine is in the critical status;
means for generating at least a synthetic data corresponding to the status of the medical machine, the synthetic data being represented on the display and being visually characterised in a way which is differentiated according to the status of the medical machine, whether correctly functioning, in warning status or in critical status;
wherein the processing unit is configured to receive the predetermined amount of data relating to parameter of a medical machine a plurality of times at temporally separate moments and in that the means for generating a synthetic data generate a synthetic data corresponding to a status at each receiving of the predetermined amount of data, the synthetic data, which relate to temporally separate moments, being represented contemporaneously on the display in spatial sequence going from a most recent to a most remote synthetic data.

22. The interface of claim 21, wherein the synthetic data is visually characterised by means of different colours according to whether the medical machine is in functioning status, warning status or critical status.

23. The interface of claim 21, wherein the processing unit is a control unit configured to control at least an actuator of the medical machine.

24. The interface of claim 21, wherein the processing unit is configured to receive various groups of data relating to parameters of medical machines, the groups of data being respectively relative to a plurality of different medical machines.

25. The interface of claim 24, wherein the synthetic data corresponding to the status is generated for each of the different medical machines.

26. The interface of claim 21, wherein the processing unit is configured to define, on the display, at least an information presentation area for the synthetic data relating to the medical machine.

27. The interface of claim 21, wherein the processing unit is configured to define, on the display, at least a detailed information presentation area relating to the medical machine.

28. The interface of claim 26, wherein the synthetic data information presentation area comprises a first zone for reporting a list of the medical machines connected to the interface in at least a second zone for reporting synthetic data corresponding to a status of the machine.

29. The interface of claim 28, wherein the list of medical machines connected to the interface is located on a line or on a column, the synthetic data corresponding to the status of each machine being reported on a respective line or following column.

30. The interface of claim 29, wherein the synthetic data corresponding to the status of each medical machine are correspondingly reported on a plurality of lines or columns, starting from a temporally most recent synthetic data and going to a temporally most remote synthetic data.

31. The interface of claim 26 further comprising means for selecting active in the synthetic data presentation area for selecting an element chosen in the group including a medical machine and a synthetic data, the processing unit being configured to display detailed data relating to various parameters of the medical machine and selected synthetic data.

32. The interface of claim 31, wherein the detailed data relating to the various parameters are displayed in a detailed information presentation area.

33. The interface of claim 31, wherein single detailed data relating to the various parameters are each displayed in a differentiated way according to which status they belong to.

34. The interface of claim 27, wherein the presentation area of detailed information and the synthetic data areas are contemporaneously displayed on the display.

35. The interface of claim 21, wherein the medical machine is a medical machine for treatment of fluids, comprising means for treatment of a fluid having:
a predetermined number of sensors for detecting functioning parameters of the medical machine, and
a predetermined number of actuators for intervening in order to modify the functioning parameters of the medical machine; a control unit of the medical machine sending command signals to the actuators and/or receiving information from the sensors.

36. A user interface for monitoring a status of medical machines, comprising:
a processing unit configured for receiving a predetermined amount of data relating to various parameters of a medical machine;
a display for visualising data coming from the processing unit and relating to the medical machine;
the processing unit comprising:
means for establishing that the predetermined amount of data coming from a same medical machine belongs to at least a status of correct functioning, or a warning status, or a critical status, the processing unit being configured to determine that the medical machine is in a condition of correct functioning when the means for establishing have determined that each of the data from the same medical machine belongs to a status of correct functioning, the processing unit being configured to determine that the medical machine is in a warning status if the means for establishing have determined that at least one datum of the data of the medical machine is in the warning status, the other data of the data not being in the critical status, the processing unit being configured to determine that the machine is in a critical status when the means for establishing have determined that at least a datum of the data of the medical machine is in the critical status;
means for generating at least a synthetic data corresponding to the status of the medical machine, the synthetic data being represented on the display and being visually characterised in a way which is differentiated according to the status of the medical machine, whether correctly functioning, in warning status or in critical status;
wherein the processing unit is configured to receive the predetermined amount of data relating to parameter of a medical machine a plurality of times at temporally separate moments and in that the means for generating a synthetic data generate a synthetic data corresponding to a status at each receiving of the predetermined amount of data, the synthetic data, which relate to temporally separate moments, being represented contemporaneously on the display in spatial sequence going from a most recent to a most remote synthetic data,
wherein the processing unit is also configured to receive various groups of data relating to parameters of medical machines, the groups of data being respectively relative to a plurality of different medical machines, the synthetic data corresponding to the status is generated for each of the different medical machines,
wherein the processing unit is configured to define, on the display, at least an information presentation area for the medical machine and for the synthetic data relating to the medical machine, the synthetic data information presentation area comprising a first zone for reporting a list of the medical machines connected to the interface in at least a second zone for reporting synthetic data corresponding to a status, of the machine, the list of medical machines, connected to the interface being located on a line or on a column, the synthetic data corresponding to the status of each machine being reported on a respective line or following column,
wherein the synthetic data corresponding to the status of each medical machine are correspondingly reported on a plurality of lines or columns, starting from a temporally most recent synthetic data and going to a temporally most remote synthetic data.

37. A graphic user interface for monitoring a status of medical machines for extracorporeal blood treatment comprising means for treatment of blood having:
a predetermined number of sensors for detecting functioning parameters of the medical machine, and
a predetermined number of actuators for intervening in order to modify the functioning parameters of the medical machine; a control unit of the medical machine sending command signals to the actuators and/or receiving information from the sensors,
the graphic user interface being configured to intuitively displaying at least a part of the data received from the control unit and relating to the sensors and the actuators working on an extracorporeal blood treatment circuit and including a touch screen showing various regions having a plurality of touch keys and a plurality of pictograms, each of which being associated to a respective touch key, the graphic user interface comprising:
a processing unit configured for receiving a predetermined amount of data relating to various parameters of a medical machine;
a display for visualising data coming from the processing unit and relating to the medical machine;
the processing unit comprising:
means for establishing that the predetermined amount of data coming from a same medical machine belongs to at least a status of correct functioning, or a warning status, or a critical status, the processing unit being configured to determine that the medical machine is in a condition of correct functioning when the means for establishing have determined that each of the data from the same medical machine belongs to a status of correct functioning, the processing unit being configured to determine that the medical machine is in a warning status if the means for establishing have determined that at least one datum of the data of the medical machine is in the warning status, the other data of the data not being in the critical status, the processing unit being configured to determine that the machine is in a critical status when the means for establishing have determined that at least a datum of the data of the medical machine is in the critical status;
means for generating at least a synthetic data corresponding to the status of the medical machine, the synthetic data being represented on the display and being visually characterised in a way which is differentiated according to the status of the medical machine, whether correctly functioning, in warning status or in critical status;
wherein the processing unit is configured to receive the predetermined amount of data relating to parameter of a medical machine a plurality of times at temporally separate moments and in that the means for generating a synthetic data generate a synthetic data corresponding to a status at each receiving of the predetermined amount of data, the synthetic data, which relate to temporally separate moments, being represented contemporaneously on the display in spatial sequence going from a most recent to a most remote synthetic data.
